(19) United States
(12) Patent Application Publication
(10) Pub. No.: US 2009/0053639 A1
(43) Pub. Date: Feb. 26, 2009

(54) DEVELOPING AGENT

(75) Inventor: Shoko Shimmura, Yokohama-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/456,713

(22) Filed: Jul. 11, 2006

(51) Int. Cl. G03G 9/083

(52) U.S. Cl. 430/106.2; 430/110.2

(57) ABSTRACT

A developing agent contains magnetic particles having a surface coated layer containing an organic material on at least a part of a surface thereof, and colored particles provided with an external additive having a weak charging property with respect to the surface coated layer of the magnetic particles on a surface of mother particles containing at least a resin and a colorant, whereby it has a high transfer efficiency, and an image with high quality can be obtained.

### BACKGROUND OF THE INVENTION

1. Field of the Invention

The present invention relates to a developing agent used in an image forming apparatus, such as a duplicator and a printer.

2. Description of the Related Art

In an image forming apparatus using an electrophotographic system, in general, a toner, which contains colored particles, is conveyed with a conveying medium, such as an electrostatic latent image carrying member, e.g., a photoreceptor, and an intermediate transfer medium, e.g., a transfer belt, and attached to a desired position on a transfer medium, such as paper. The toner is fixed to the transfer medium by pressing with a heat roller or the like to form an image on the transfer medium.

In recent years, there is such a tendency that the toner particle diameter is decreased for obtaining a high-definition image, but when the toner particle diameter becomes smaller, the charge amount of one toner particle becomes smaller to decrease the force received from an electric field, and thus both development and transferring become difficult. Furthermore, the charge amount per unit volume is increased due to the increase in surface area, and the difference in electric potential for development is bridged with the toner in a small amount, whereby it is difficult to obtain a sufficient image density by increasing the development amount. Moreover, it is necessary to increase the transferring electric field, which brings about such problems that electric discharge occurs, and transfer residue occurs due to injection of charge of the reverse polarity.

In the case where a toner having a small particle diameter is used, it is difficult to remove completely a toner remaining after transferring with a cleaner, such as a rubber blade, and therefore, application of a cleaner-less process is being considered. In the cleaner-less process, when the toner remaining after transferring occurs, the next steps including charging of the photoreceptor and formation of a latent image are performed, and then the remaining toner on the non-image part is recovered to the developing device upon developing a new image part. Accordingly, in the case where the amount of the toner remaining after transferring is large due to a poor transfer efficiency, the light source for forming a latent image is shielded, and the remaining toner is again transferred due to failure in recovery to the developing device, which bring about image defects.

In a color image forming apparatus having a tandem configuration, there may be such a case that a toner transferred from an image carrying member to an (intermediate) transfer medium receives a transferring electric field in the transfer area from an image carrying member in the subsequent step and is pressed onto the image carrying member in the subsequent step to cause reverse transfer. When the toner thus reversely transferred is recovered to the developing device in the cleaner-less process, the toner of color of the preceding unit is mixed therein, and the color management becomes impossible when the mixing amount is increased. The transfer efficiency and the reverse transfer efficiency are capabilities opposed to each other, and in order to prevent an irretrievable state caused by color mixing due to reverse transfer from occurring, it is necessary to employ such a transfer condition that is capable of preventing reverse transfer from occurring even though the transfer capability is sacrificed in some extent, and thus a further higher transfer efficiency is required.

As having been required, improvement in transfer efficiency is demanded for reducing the particle diameter of the toner, applying the cleaner-less process, and realizing full color images. Various measures using an external additive, such as inorganic fine particles and resin fine particles, have been proposed therefor. For example, JP-A-2002-214825 proposes the use of spherical toner mother particles and two or more kinds of inorganic fine particles having different particle diameters, where at least one kind of the inorganic fine particles are spherical fine particles of 80 to 300 nm, and have a surface coverage of the toner mother particles of 20% or more. However, in the case where the coverage is simply increased, the charge application function to the toner particles by the magnetic particles as a carrier depends largely on the inorganic fine particles but not on the toner mother particles. Accordingly, such problems occur as nonuniformity in charge distribution on the toner surface, and fluctuation in toner charge amount due to release of the fine particles.

JP-A-2004-163612 proposes the use of negatively charging resin fine particles having a particle diameter of from 80 to 300 nm as an external additive. However, in the case where negatively charging particles intervene between a toner and magnetic particles applying charge to the toner, the fine particles are negatively charged strongly due to friction between the magnetic particles and fine particles. There is also disclosed that the addition amount of the fine particles is from 1 to 3%, but the fine particles are scattered on the surface of the toner mother particles to cause charge scattered nonuniformly. Accordingly, the fine particles function as protrusions having a large charge density scattered on the surface of the toner mother particles, and thus the adhesion force of the toner to the medium becomes significantly increased to make transfer difficult.

### SUMMARY OF THE INVENTION

The invention is to provide such a developing agent that has a high transfer efficiency and is capable of providing an image with high quality.

According to one aspect, the invention provides a developing agent including colored particles containing mother particles, the mother particles containing at least a resin and a colorant, and a first external additive, the first external additive covering a surface of the mother particles, and magnetic particles having a surface coated layer on at least a part of a surface thereof, the surface coated layer thereof containing an organic material, and a charge amount q₁ per weight of the mother particles with respect to the surface coated layer and a charge amount q₂ per weight of the colored particles with respect to the surface coated layer satisfy |q₁|≧|q₂|.

According to another aspect, the invention provides a developing agent including colored particles containing mother particles, the mother particles containing at least a resin and a colorant, and a first external additive, the first external additive covering a surface of the mother particles, and magnetic particles having a surface coated layer on at least a part of a surface thereof, the surface coated layer thereof containing an organic material, and wherein a charge amount qₜ per surface area of the mother particles with respect to the surface coated layer and a charge amount q₀ per weight of the external additive with respect to the surface coated layer satisfy |qₜ|≧|q₀|.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1a is a schematic view explaining a strength of a mutual attraction force to an adherent in the case where charging fine particles are present on a surface of colored particles in one embodiment of the invention;

FIG. 1b is a schematic view explaining a strength of a mutual attraction force to an adherent in the case where non-charging fine particles are present in one embodiment of the invention;

FIG. 2 is a perspective view showing a sample set for measuring an average attached amount of toner particles in one embodiment of the invention;

FIG. 3 is a cross sectional view showing a cell for measuring an average attached amount of toner particles in one embodiment of the invention;

FIG. 4a is a perspective view showing an angle rotor for measuring an average attached amount of toner particles in one embodiment of the invention;

FIG. 4b is a cross sectional view showing an angle rotor for measuring an average attached amount of toner particles in one embodiment of the invention;

FIG. 5 is a conceptual illustration showing an image forming apparatus by a two-component developing process in one embodiment of the invention;

FIG. 6 is a conceptual illustration showing an image forming apparatus by a cleaner-less process in one embodiment of the invention;

FIG. 7 is a conceptual illustration showing an image forming apparatus by a four-unit tandem process in one embodiment of the invention;

FIG. 8 is a conceptual illustration showing an image forming apparatus by a four-unit tandem process equipped with an intermediate transfer medium in one embodiment of the invention;

FIG. 9 is a graph showing relationship between a degree of circularity of mother particles and an adhesion force in one embodiment of the invention;

FIG. 10 is a graph showing relationship between a degree of circularity of mother particles and a transfer efficiency in one embodiment of the invention;

FIG. 11 is a graph showing relationship between a coverage of mother particles and an adhesion force in one embodiment of the invention;

FIG. 12 is a graph showing relationship between a coverage of mother particles and a transfer efficiency in one embodiment of the invention; and

FIG. 13 is a graph showing relationship between a fluctuation coefficient of a charging rate and a coverage of mother particles in one embodiment of the invention.

### DETAILED DESCRIPTION OF THE EMBODIMENTS

The developing agent according to one embodiment of the invention contains mother particles, the mother particles containing at least a resin and a colorant, and a first external additive, the first external additive covering a surface of the mother particles, and magnetic particles having a surface coated layer on at least a part of a surface thereof, the surface coated layer thereof containing an organic material, and a charge amount q₁ per weight of the mother particles with respect to the surface coated layer and a charge amount q₂ per weight of the colored particles with respect to the surface coated layer satisfy |q₁|≧|q₂|.

The developing agent according to another embodiment of the invention contains a developing agent including colored particles containing mother particles, the mother particles containing at least a resin and a colorant, and a first external additive, the first external additive covering a surface of the mother particles, and magnetic particles having a surface coated layer on at least a part of a surface thereof, the surface coated layer thereof containing an organic material, and wherein a charge amount qₜ per surface area of the mother particles with respect to the surface coated layer and a charge amount q₀ per weight of the external additive with respect to the surface coated layer satisfy |qₜ|≧|q₀|.

The average adhesion force of the colored particles, which govern the transfer efficiency, to a medium is obtained theoretically as a sum of an electrostatic adhesion force and a non-electrostatic adhesion force. Even in the case where the charge amount per weight of the colored particles is high, in order to improve the transfer efficiency, it is considered to reduce the non-electrostatic adhesion force, which does not depend on the charge amount. A method of making the colored particles into a spherical form can be considered therefor, but it brings about a problem of difficulty in blade cleaning. A method of using a large amount of a lubricant is also considered, but there is a limitation in using amount, and it brings about a problem of difficulty in controlling the charge amount simultaneously. Such a problem is also brought about that the amount of the lubricant in the developing device is fluctuated with lapse of time and is difficult to be controlled.

Under the circumstances, such a measure is investigated that the electrostatic adhesion force is not increased even though the charge amount per weight of the colored particles is large. It has been known that the measured value of the electrostatic adhesion force of the colored particles is from five to ten times the theoretical value of the electrostatic adhesion force of spherical particles that are ordinarily used. For example, according to Journal of Imaging Science and Technology, vol. 48, No. 5 (2004), it is expressed by the following expression:

Fi=α·q²/4πε₀D²

ε₀: dielectric constant of vacuum

α: correction coefficient ascribable to difference in dielectric constant between photoreceptor and colored particles

q: charge amount of one colored particle

D: particle diameter of colored particle

and the difference between the measured value and the theoretical value is also considered. Japan Hardcopy, 2005, B-13 similarly makes consideration for theorizing the measured value. However, such a theory has not yet been established that clearly explains the mechanism causing the difference between the measured value and the theoretical value.

Examples of the factors therefor include the following: fine particles are externally added to the surface of the colored particles for such purposes as improvement in fluidity, and the particle diameter and the shape thereof are various; non-spherical particles, such as irregular particles, potato-like particles and rugby ball-like particles, prepared by a pulverizing method or a chemical Preparation method are ordinarily used, but truly spherical colored particles are not always used; and the colored particles are constituted by a pigment, a resin, a charge controlling agent, a lubricant and the like, and are not uniform particles.

Accordingly, it is considered that such factors that are not explicable from the known physical values, such as the particle diameter and the charge amount, influence the electrostatic adhesion force. The inventors have made investigations on an external additive based on such an assumption that the charge distribution on the surface of the colored particles including the external additive is not uniform, the distance between the site where the charge exists and the adhesion surface varies depending on the colored particles, but a point charge does not exist at the center of spherical particle, which is the case in the calculation expression. As a result, it has been found that the electrostatic adhesion force is governed not only by the particle diameter and the charge amount of the colored particles, but also by the charge characteristics, the particle diameter and the state of external addition of the external additive. For example, it is considered that when an external additive exhibiting weak charging property from the magnetic particles and having a relatively large particle diameter is externally added to the colored particles in a prescribed condition, the site of the charge can be made away from the adherent to suppress the electrostatic adhesion force from being increased.

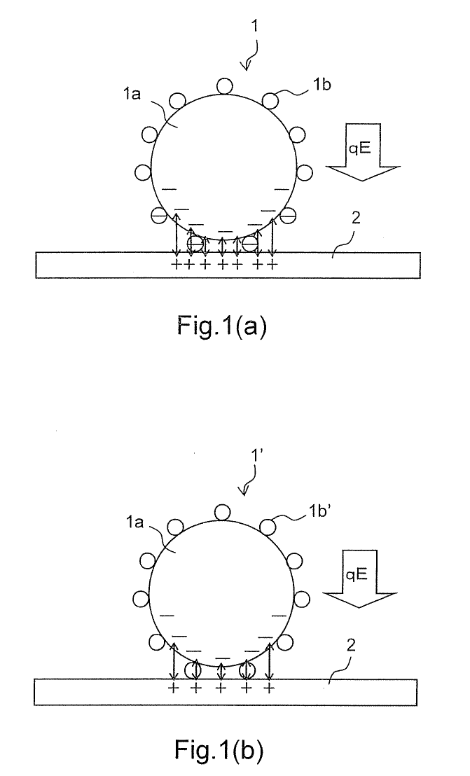

FIG. 1a is a schematic view explaining the strength of the mutual attraction force to the adherent in the case where charging fine particles are present on the surface of the colored particles, and FIG. 1b is a schematic view explaining the same in the case where non-charging fine particles are present thereon. The surface of a conveying member as the adherent, on which the colored particles are to be adhered, is a curved surface in practice, but is expressed by a flat surface since it has a large curvature as compared to the colored particles.

The colored particles are applied with charge through contact and friction with the surface coated layer of the magnetic particles. In the case where fine particles 1b that are charged through contact with the surface coated layer are present on the surface of the mother particle 1a of the colored particle 1 as shown in FIG. 1a, the charge of the colored particle 1 is generated not only on the surface of the mother particle 1a but also in the fine particles 1b. Upon placing in an electric field for conveying, the colored particle 1 is polarized due to the electric field, and the charge is concentrated in the vicinity of the dielectric material (adherent) 2, with which the colored particle is made in contact, to reduce the distance between the charges, whereby a strong electrostatic attraction force is generated. Furthermore, the distance between the charges is decreased, and thus the charges locally exist, whereby the electrostatic adhesion force is increased.

In the case where fine particles 1b that are not charged through contact with the surface coated layer are present on the surface of the colored particle 1 as shown in FIG. 1b, the charge of the colored particle 1 is generated on the surface of the mother particle 1a. Upon placing in an electric field for conveying, the colored particle 1′ is similarly polarized due to the electric field, and the charge is concentrated in the vicinity of the dielectric material (adherent) 2, with which the colored particle is made in contact, to reduce the distance between the charges, whereby a strong electrostatic attraction force is generated. However, the fine particles 1b′ that do not have the same charge as the charge of the mother particle intervene as a spacer, whereby the distance between the charges is increased to reduce the electrostatic adhesion force. Accordingly, the electrostatic adhesion force varies depending on the site where the charge exists while the charge amount of the colored particles containing the external additive is identical.

As the external additive (first external additive) functioning as the spacer controlling the site of charge, inorganic fine particles, such as silica, alumina and titanium oxide, and organic fine particles are used. The external additive is not charged even in contact with the magnetic particles as a carrier, but simply has a function of suppressing the electrostatic adhesion force as a spacer. The volume average particle diameter of the primary particles thereof is preferably from 50 to 500 nm. In the case where it is less than 50 nm, the effect as the spacer separating the charges cannot be sufficiently obtained, and in the case where it exceeds 500 nm, the fixing property, the transparency and the coloring property of the toner particles might be impaired, and the photoreceptor might be damaged. It is more preferably from 70 to 200 nm.

The external additive can be identified by the known qualitative analytical method, such as the emission spectrometry, the atomic absorption spectrometry, the absorption spectrometry, the X-ray or fluorescent X-ray spectrometry, the infrared spectrometry and the gas chromatography, appropriately depending on the kind thereof.

The coverage of the external additive on the surface of the mother particles of the colored particles is preferably from 5 to 40%. In the case where it is less than 5%, the function as the spacer cannot be sufficiently obtained. When the coverage is increased, the electrostatic adhesion force is reduced due to the contribution of the spacer effect, and the transfer electric field is decreased because of the following relationship:

Transfer electric field E=Adhesion force F/charge amount q

but when it exceeds about 20%, the contact area between the external additive and the adherent, such as the photoreceptor, is increased, whereby the non-electrostatic adhesion force is increased to increase the necessary transfer electric field. When the necessary transfer electric field is increased, electric discharge occurs in the transfer area to invert the polarity of the charge of the toner particles, which remain on the photoreceptor due to transfer failure. The transfer residual amount is desirably 95% or more, and the transfer electric field is necessarily 2.5×10⁷ V/m or less therefor. When the addition amount is increased, the charge capability of the colored particles is governed by the external additive, and the charge amount of the colored particles might be largely fluctuated by releasing the external additive due to mechanical stress, such as lapse of life. Furthermore, there are cases where the external additive is charged to a reverse polarity to the mother particles to increase the adhesion force, and the contact of the magnetic particles and the mother particles is impaired to fail to obtain a charge amount that can be controlled with the electric field, which brings about problems of fogging and scattering of the colored particles. Accordingly, the coverage is necessarily 40% or less. It is more preferably less than 20%.

The coverage of the external additive herein can be measured, for example, by the following manner.

### (Measurement of Coverage of External Additive)

A micrograph of the colored particles having the external additive attached thereto is taken with an SEM (scanning electron microscope) at such a magnification that the external additive can be clearly recognized, and subjected to image processing to obtain the coverage as a ratio of the total projected area of the external additive attached to the surface of the mother particles to the projected area of the mother particles. The coverage is measured for 20 to 100 colored particles, and an average value is obtained.

The mother particles of the colored particles covered with the external additive are constituted by at least a binder resin, such as a polyester resin and a styrene-acrylic resin, and a colorant, such as known pigments and dye, e.g., carbon black, a condensed polycyclic pigment, an azo pigment, a phthalocyanine pigment and an inorganic pigment. Other known components, such as a fixing assistant, such as wax, and a charge controlling agent (CCA), may also be used. The mother particles are formed by the pulverizing method or the chemical method, which have been known in the art.

The mother particles are preferably in a planular shape or a spherical shape with a degree of circularity of from 0.94 to 1. This is because the external additive is prevented from being buried into recessions on the surface of the mother particles, whereby the spacer effect is prevented from being lost. In the case where the degree of circularity is low, the spacer effect cannot be obtained to increase the adhesion force, which requires a large transfer electric field. Furthermore, charge injection and polarity inversion of the toner are liable to occur, which cause transfer residue and reverse transfer. The degree of circularity herein can be measured in the following manner.

### (Measurement of Degree of Circularity of Toner Particles)

The circumferential length D1 calculated from the projected area of the particle and the diameter of the true circle with equal area and the circumferential length D2 of the projected particle are obtained with a flow type particle image analyzer, FPIA-3000, produced by Sysmex Corp., and the degree of circularity is designated as D1/D2 (which becomes 1 in the case of true circle (true sphere)).

The average adhesion force F(N) of the toner particles to the medium is measured in the following manner by using a separation ultracentrifugal machine (CP100MX), an angle rotor (P100AT2), and a cell produced for measuring an adhesion force of powder, all produced by Hitachi Koki Co., Ltd.

### (Measurement Method for Average Adhesion Force F(N))

(1) A sheet having a surface protective layer, which is equivalent to that in a photoreceptor sheet as a target for measuring the adhesion force is produced. At this time, a charge generation layer (CGL) and a charge transporting layer (CTL) may be accumulated as similar to the photoreceptor actually used. The sheet is wound on a simple aluminum tube to ground the photosensitive layer. The assembly is set at the position of the photoreceptor drum, and the toner is developed and attached to the surface thereof as similar to the ordinary image forming operation.

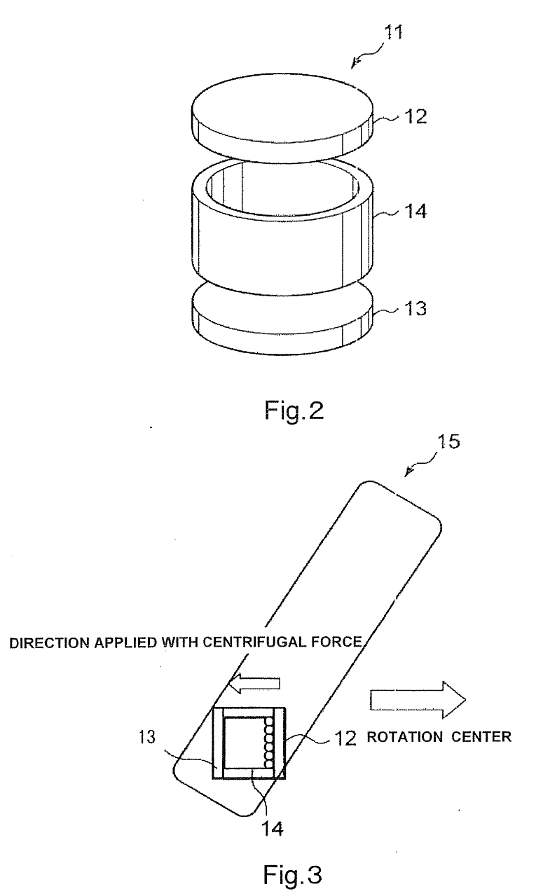

(2) The sheet having the toner attached thereto is placed in a sample set. As shown in FIG. 2, the sample set 11 is constituted by a plate A 12, a plate B 13 and a cylindrical spacer 14. The plate A 12, the plate B 13 and the cylindrical spacer 14 have an outer diameter of 7 mm, and the spacer 14 has a thickness of 1 mm and a height of 3 mm. The sheet having the toner attached thereto is cut into the size of the plate A and adhered with a double face adhesive tape to the side of the plate A 12, which is in contact with the spacer.

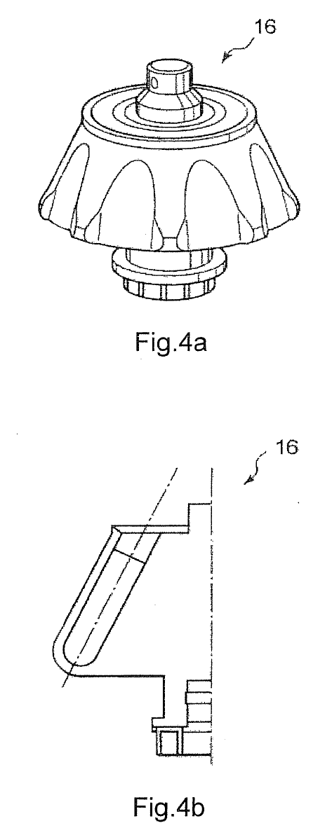

(3) As shown in FIG. 3, the sample set is placed in a cell 15. The cell 15 is placed in an angle rotor 16 shown in FIGS. 4(a) and (b) in such a manner that the back surface of the side of the plate A 12 having the sample adhered thereto faces toward the rotation center, and the angle rotor 16 is placed in an ultracentrifugal machine (which is not shown in the figures).

(4) After operating the ultracentrifugal machine at 10,000 rpm, the plates A and B are taken out, and the toner particles attached to them are removed with mending tapes, which are adhered to white paper. The reflection densities of the mending tapes having the toner particles attached thereto are measured with a Macbeth densitometer.

(5) A proofing formula of the reflection density with respect to the toner amount is separately prepared in advance, and the amount of the toner separated and the amount of the toner not separated are calculated by referring the formula.

(6) The sheet having the toner attached thereto is cut and adhered to the plate A similarly to the item (2) and placed in the ultracentrifugal machine similarly to the item (3). The ultracentrifugal machine is operated at 20,000 rpm, and the plates are taken out similarly to the item (4), and the amounts of the toner attached to the plate A and the plate B are measured. The same operation is repeated until 100,000 rpm by 10,000 rpm.

(7) The centrifugal acceleration RCF applied to the sample set in the cell by rotation of the rotor is expressed by the following expression:

RCF=1.118×10⁻⁵×r×N²×g
r: distance between sample set position and rotation center
N: number of revolution (rpm)
g: gravity acceleration
   and the centrifugal force F applied to the toner particles is expressed with the weight m of one toner particle by the following expression:

F=RCF×m

m=(4/3)π×r³×ρ
r: true sphere equivalent radius
ρ: specific gravity of toner
   Accordingly, the sum of values obtained by multiplying the centrifugal forces F applied to the toner by the ratios of the separated toner, respectively, for each rotation number is designated as the average adhesion force F(N) of the toner and the photoreceptor in the developing agent.

The volume average particle diameter thereof is preferably from 2.5 to 7 μm. In the case where it is less than 2.5 μm, the charge amount per one particle is too small with the identical charge amount per weight, and thus the behavior thereof is difficult to control by the force of the electric field. In the case where it exceeds 7 μm, reproducibility of a high definition image is deteriorated. It is more preferably from 3 to 6 μm.

It is preferred that the external additive is attached to the mother particles at such a strength that the external additive is not released from the surface of the mother particles in the developing and transferring steps, but is partially released under pressure contact stress applied with a cleaner.

The mother particles may contain an external additive having a smaller particle diameter (second external additive) for improvement in flowability and control of the charging property of the mother particles. As the external additive, for example, particles having a volume average particle diameter of primary particles thereof of from 10 to 100 nm may be used. When the particles are too small, they are buried on the surface to fail to provide improvement in flowability, and when they are too large, there are some cases where they cancel the effect of the first external additive, but the range of the particle diameter is not particularly limited unless these problems occur.

The magnetic particles are used as a carrier, and ferrite, magnetite, iron oxide or resin particles mixed with magnetic powder or the like may be used. A surface coated layer is provided on at least a part of the surface thereof. The surface coated layer preferably contains the same material as the external additive (first external additive) for preventing charge from occurring upon contact and friction with the external additive. The volume average particle diameter of the magnetic particles is desirably from 20 to 100 μm. In the case where it is less than 20 μm, the magnetic force per one particle is too weak to cause adhesion of the carrier, and in the case where it exceeds 100 μm, the magnetic brush becomes rough and hard to fail to develop densely, and brush lines are formed on an image. It is preferably from 35 to 60 μm.

In the developing agent prepared by using the materials, it is necessary that the external additive is not charged upon contact with the magnetic particles. Specifically, it is necessary that the charge amount q₁ per weight of the mother particles with respect to the surface coated layer and the charge amount q₂ per weight of the colored particles with respect to the surface coated layer satisfy |q₁|≧|q₂|, or in alternative, the charge amount qₜ per surface area of the mother particles with respect to the surface coated layer and the charge amount q₀ per weight of the external additive with respect to the surface coated layer satisfy |qₜ|≧|q₀|. The charge amounts herein can be measured in the following manner.

(Measurement of Charge Amount q₁ of Mother Particles and Charge Amount q₂ of Colored Particles)

(1) The developing agent containing the magnetic particles and the colored particles is taken out from the developing device. A given amount of the developing agent is subjected to a suction blow off device to measure the charge amount of the colored particles. The developing agent is washed with water containing a small amount of a surfactant to remove the colored particles, and the remaining magnetic particles are sufficiently dried. The mixing ratio of the colored particles in the developing agent is measured from the difference between the weights before and after removal of the colored particles. The charge amount q₁ per weight of the colored particles with respect to the surface coated layer of the magnetic particles is calculated from the charge amount and the mixing ratio of the colored particles thus measured.

(2) The developing agent is placed on a sieve having a pore diameter that is smaller than the diameter of the magnetic particles and sucked below to separate the colored particles.

(3) The colored particles thus separated are placed in a wind classification apparatus and passed through a cyclone having an air flow amount (differential pressure) of from 600 to 800 mmHg. The external additive attached to the surface of the colored particles is released from the surface of the particles and removed from the upper part of the cyclone, and the colored particles are recovered from the lower part of the cyclone. At this time, the air flow amount (differential pressure) may be appropriately controlled by confirming as to whether or not the external additive is released through SEM observation of the surface of the particles before and after passing through the cyclone. In order to release the external additive more certainly, the external additive may be subjected to the cyclone in plural times. The external additive may not be entirely released herein. The charge amount ratio of the colored particles before and after the external addition can be measured when such an amount of the external additive is released that it can be recognized that the attached amount is apparently decreased.

(4) The colored particles thus recovered are mixed with the carrier particles separated from the colored particles in the item (2) at the same ratio as the mixing ratio of the colored particles measured in the item (1), and then well mixed for charging. The mixture is placed in a PE container, which is then placed in a turbulence mixer, Model T2C, produced by Willy A. Bachofen AG (Basel, Switzerland), followed by agitating for 60 minutes. A given amount of the mixture is subjected to a suction blow off device to measure the charge amount of the colored particles, and the charge amount q₂ per weight is calculated.

(Measurement of Charge Amount qₜ of Mother Particles and Charge Amount q₀ of External Additive)

The magnetic particles, the mother particles and the external additive are separated and recovered, respectively, in the same manner as in the aforementioned items (1) to (3). The magnetic particles and the mother particles thus recovered are mixed at the same ratio as the mixing ratio of the developing agent and then agitate, and the charge amount distribution and q/S (charge amount per surface area)=qt are measured by using E-Spart Analyzer, produced by Hosokawa Micron Corp. Similarly, the magnetic particles and the external additive are mixed at a ratio lower than the mixing ratio of the developing agent and then agitated, and the charge amount distribution and q/S=q₀ are measured similarly by using E-Spart Analyzer.

By using the colored particles, firstly, the colored particles can be suppressed from being scattered in a state with a low charge amount owing to the relatively large specific electrostatic adhesion force of the colored particles. While the force of the electric field is increased in proportion to the charge amount of the colored particles, the electrostatic adhesion force can be suppressed from being increased, whereby control in migration of the colored particles with the electric field of development and transfer is facilitated. Accordingly, the transfer efficiency can be improved without deterioration in image quality.

An image is formed by using the developing agent, for example, through the following developing process.

### (Two-Component Developing Process)

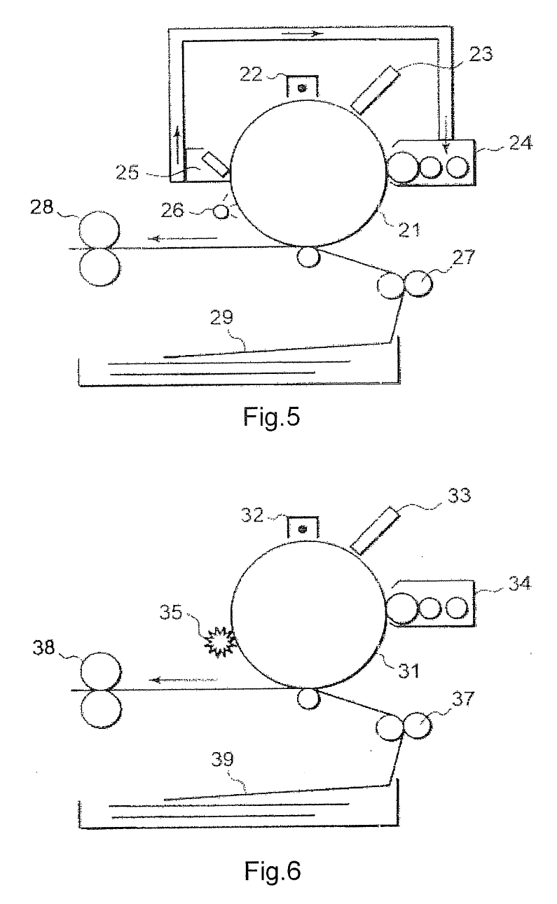

FIG. 5 shows an image forming apparatus by the two-component developing process. As shown in the figure, an electrostatic latent image carrying member 21, a charging device 22 for charging it, an exposing device 23 for forming an electrostatic latent image, a developing device 24 for feeding toner particles to the electrostatic latent image, a cleaner 25 for removing the toner remaining after transferring, a destaticizing lamp 26 for removing the electrostatic latent image, a paper feeding device 27 for feeding paper as a final transfer medium, and a fixing device 28 for fixing a toner image to the paper are disposed. An image is formed on a transfer medium 29 by using the image forming apparatus through the following process.

(1) The electrostatic latent image carrying member 21, such as a belt and a roller, is uniformly charged to a desired potential with the known charging device 22, such as a corona charging device, e.g., a scorotron, a charger wire, an interdigitated charger, a contact charging roller, a non-contact charging roller and a solid charger. As the electrostatic latent image carrying member 21, a known photoreceptor, such as a positively charging or negatively charging OPC (organic photoconductor) and amorphous silicon is used. In the photoreceptor, a charge generating layer, a charge transporting layer and a protective layer may be accumulated, or a layer having functions of plural layers among these layers may be formed.

(2) The electrostatic latent image carrying member 21 is exposed with the exposing device 23 using a known measure, such as a laser and an LED, to form an electrostatic latent image thereon.

(3) In the developing device 24, a two-component developing agent containing a carrier and a toner is housed in a hopper in an amount, for example, of from 100 to 700 g. The developing agent is fed to a developing roller having a mag roller with an agitating auger. The charged toner particles are fed and attached to the electrostatic latent image on the electrostatic latent image carrying member 21 by using a magnetic brush as a developing agent carrying member to develop the latent image as a visualized image on the electrostatic latent image carrying member 21. At this time, the developing roller is applied with a developing bias of a direct current with an alternating current accumulated thereon for forming an electric field for attaching the toner particles uniformly and stably.

The toner particles having not been developed are released from the developing roller at the releasing pole position of the mag roller and are recovered to the developing agent container with an agitating auger. The developing agent container is equipped with a known toner concentration sensor, and when the concentration sensor detects decrease in toner amount, a signal is sent to the toner feeding hopper to feed a new toner. At this time, it is also possible that the toner consumption amount is estimated from accumulation of printing data and/or detection of the developed toner amount on the photoreceptor, and a new toner is fed based on the estimation. Both measures of the sensor output and the estimation of consumption amount may be used.

(4) The toner image thus formed is transferred to the transfer medium 29, such as paper, by using a known transferring means, such as a transfer roller, a transfer blade and a corona charger, directly or through an intermediate transfer medium, such as a belt and a roller.

(5) The transfer medium 29 having the toner image transferred thereto is released from the intermediate transfer material or the electrostatic latent image carrying member 21 and conveyed to the fixing part 28 for fixing with a known heating and pressurizing fixing system, such as a heat roller, followed by discharging to the exterior of the apparatus.

(6) The toner remaining on the electrostatic latent image carrying member 21 but not being transferred after transferring the toner image is removed with the cleaner 25, and the electrostatic latent image on the electrostatic latent image carrying member 21 is erased with the destaticizing lamp 26.

(7) The toner remaining after transferring thus removed with the cleaner 25 is stored in a waste toner container with an agitating auger or the like through a conveying path, and then discharged. In a recycling system, the toner is recovered to the developing agent container of the developing device 24 through a conveying path, and then reused.

### (Cleaner-Less Process)

In the cleaner-less process, an image is formed similarly with the similar image forming apparatus as in the two-component developing process, but the apparatus used is different therefrom in that no cleaner is used as shown in FIG. 6. The toner remaining after transferring is recovered simultaneously with development by using no cleaner.

As similar to the two-component developing process, an electrostatic latent image carrying member 31 is charged and exposed, is then developed by attaching toner particles, and the toner image is transferred to a transfer medium 39 directly or through an intermediate transfer medium. The toner remaining after transferring in a non-image part is left remaining on the electrostatic latent image carrying member 31, and conveyed again to the developing area through the next steps of destaticizing, charging with the charging device 32 and exposing with the exposing device 33. The toner remaining after transferring is recovered to the developing device 34 with a magnetic brush as a developing agent carrying member and then newly used for developing.

At this time, a memory disturbance member 35, such as a fixed brush, felt, a rotating brush and a side sliding brush, may be disposed before or after the destaticizing step. Furthermore, it is also possible that a temporarily recovering member is disposed to recover once the toner remaining after transferring, and then the toner is discharged again onto the electrostatic latent image carrying member 31 and recovered with the developing device 34. In order to control the charge amount of the toner remaining after transferring to a desired value, a toner charging device may be disposed on the electrostatic latent image carrying member 31. One member may have functions of a part or all of the toner charging device, the memory disturbance member, the temporarily recovering member and the charging device. These members may be applied with a positive or negative voltage for exerting the functions thereof efficiently.

For example, two side sliding brushes, which exert all functions of the three members, the toner charging device, the memory disturbance member and the temporarily recovering member, are disposed between the transfer are and the charging member of the electrostatic latent image carrying member 31 in such a manner that tip ends of the brushes are in contact with the electrostatic latent image carrying member 31. The brush on the upstream side is applied with a voltage of the same polarity as the charge of the developing toner, and the brush on the downstream side is applied with a voltage of the opposite polarity to the charge of the developing toner. The toner remaining after transferring contains a toner having the opposite polarity and a toner having a considerably high charge of the same polarity, and the toner having the opposite polarity in contact with the brush having the same polarity escapes therethrough by inverting the charge or is once recovered with the brush. The toner remaining after transferring that reaches the brush having the opposite polarity on the downstream side entirely has the same polarity as the developing toner, and the toner escapes through the brush by relaxing the strong charge of the same polarity by making in contact with the brush or is once recovered with the brush. The toner remaining after transferring, which thus has a small charge amount and loses the image structure through mechanical contact with the brush, is charged along with the electrostatic latent image carrying member 31 in a non-contact manner with the charging member of the electrostatic latent image carrying member 31, so as to have such a charge amount that is equivalent to the developing toner. Accordingly, the toner remaining after transferring in a non-image part of a new latent image is recovered to the developing device 34 in the developing area, and the toner remaining after transferring in an image part thereof is transferred as it is to a transfer medium along with toner particles that are newly fed from the developing device 34.

### (Four-Unit Tandem Process)

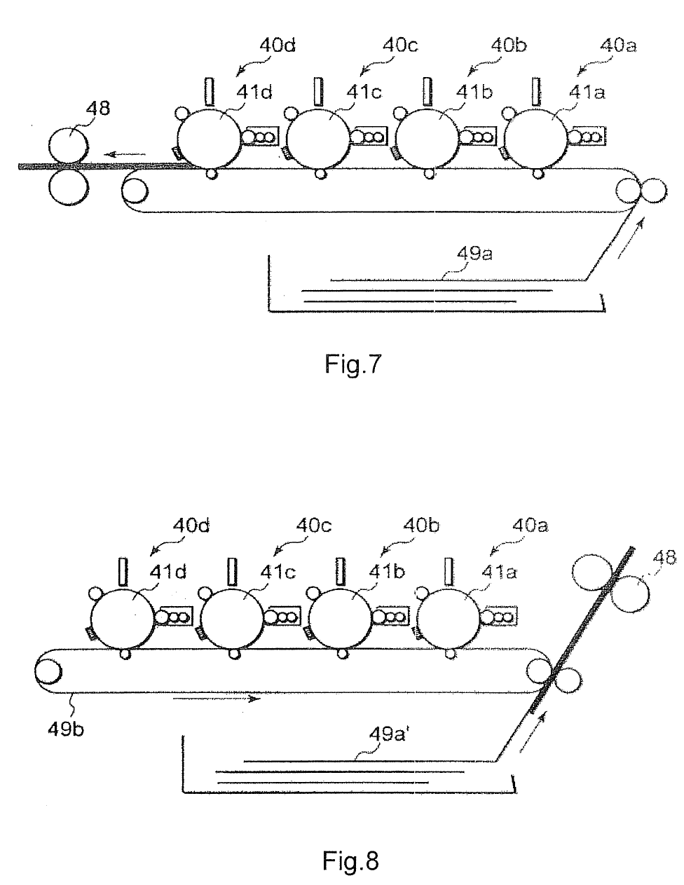

FIG. 7 shows an image forming apparatus by the four-unit tandem process. As shown in figure, image forming units 40a, 40b, 40c and 40d of four colors are disposed, each of which contains a developing device housing toner particles of yellow, magenta, cyan or black colors, respectively, an electrostatic latent image carrying member, and charging, exposing and transferring devices, and arranged in series along the conveying path of a transfer medium 49a. A fixing device 48 for fixing a toner image to paper is disposed as similar to FIG. 2. An image is formed by using the image forming apparatus in the following process. The case where the units of yellow, magenta, cyan and black colors are arranged in this order is described herein.

(1) In the yellow image forming unit, a yellow toner image is formed on an electrostatic latent image carrying member 41a and transferred to a transfer medium 49a. In the case of direct transfer, paper or the like as the final transfer medium is conveyed with a conveying member, such as a transfer belt or a roller, and fed to a transfer area of the yellow image unit. As the transfer belt, a rubber material, such as ethylene propylene rubber (EPDM) and chloroprene rubber (CR), and a resin material, such as polyimide, polycarbonate, polyvinylidene difluoride (PVDF) and ethylene tetrafluoroethylene (ETFE), are used. A resin sheet lined with a rubber layer, and a resin sheet having an elastic layer laminated thereon, which may further has a surface protective layer to form a multilayer structure, may also be used. The surface resistance of the transfer belt is desirably from 10⁷ to 10¹² Ωcm. As the transfer system, a known transfer means, such as a transfer roller, a transfer blade and a corona charger, may be used.

An intermediate transfer medium 49b may be provided as shown in FIG. 8, and in this case, the intermediate transfer medium 49b in the form of a belt or a roller is provided to pass sequentially through the transfer areas of the image forming units 40a, 40b, 40c and 40d. As the intermediate transfer belt, the similar material as the transfer belt is used in terms of material and surface resistance, and the volume resistance is, for example, 10⁹ Ωcm.

(2) In the magenta image forming unit 40b, a magenta toner image is formed on an electrostatic latent image carrying member 41b. The transfer medium 49a having the yellow toner image formed thereon is fed to the transfer area of the magenta image forming unit 40b, and the magenta toner image is transferred onto the yellow toner image with positioning. At this time, the yellow toner on the transfer medium may be reversely transferred to the magenta electrostatic latent image carrying member 41b in some cases through contact with the magenta electrostatic latent image carrying member 41b depending on the charge amount of the toner and the intensity of the transfer electric field.

(3) In the cyan and black image forming units 40c and 40d, toner images are similarly formed and transferred sequentially further onto the transfer medium 49a. On cyan and black electrostatic latent image carrying members 41c and 41d, the toner in the preceding step may be reversely transferred similarly in some cases.

(4) The transfer medium 49a having the toners of four colors accumulated is released from the conveying member and fed to the fixing device 48 for fixing with a known heating and pressurizing fixing system, such as a heat roller, followed by discharging to the exterior of the apparatus. In the case where the intermediate transfer medium 49b is used, the toner images of four colors are transferred at once to a final transfer medium 49a′, such as paper, with a secondary transfer means, and then transferred to the fixing device 48 for fixing similarly, followed by discharging to the exterior of the apparatus.

In each of the image forming units, as similar to the two-component developing process, the electrostatic latent image carrying member 41a, 41b, 41c or 41d is destaticized, and the toner remaining after transferring and the toner reversely transferred are removed in the cleaning step, followed by returning to the image forming process. In the developing device, the specific concentration of the toner is controlled as similar to the aforementioned two-component developing process. The embodiment where the image forming units of yellow, magenta, cyan and black colors are arranged in this order has been described herein, but the order of colors is not particularly limited thereto.

### (Four-Unit Tandem Cleaner-Less Process)

In the four-unit tandem cleaner-less process, an image is formed similarly with the similar image forming apparatus as in the four-unit tandem process, but the apparatus used is different therefrom in that no cleaner is used as similar to the aforementioned cleaner-less process. The toner remaining after transferring and the toner reversely transferred are recovered simultaneously with development by using no cleaner.

The invention will be described specifically below with reference to examples. In the examples and comparative examples, the volume average particle diameter was measured by using COULTER MULTISIZER II (produced by Coulter Electronics, Ltd.).

### EXAMPLE 1

Colored particles and magnetic particles were prepared in the following manner and evaluated.

### (Preparation of Mother Particles)

Mother particles as a raw material of respective colored particles were prepared. 28 parts by weight of a polyester resin, 7 parts by weight of Carmine 6B7, 5 parts by weight of rice wax and 1 part by weight of carnauba wax were kneaded with Kneadex, produced by YPK Corp. to produce a master batch. After coarsely pulverizing, 58 parts by weight of a polyester resin and 1 part by weight of CCA were added thereto, and after kneading, coarsely pulverizing and finely pulverizing, particles of 10 μm or more and 3 μm or less were removed by elbow jet classification to produce colored resin particles having a volume average particle diameter of 7.0 μm and a degree of circularity of 0.87. The colored resin particles were subjected a conglobation treatment to make into a potato-like shape having a degree of sphericity of 0.94. 2 parts by weight of silica fine particles having a volume average particle diameter of primary particles of 20 nm and having been subjected to a hydrophobic treatment and 0.7 part by weight of rutile type titanium oxide having a volume average particle diameter of primary particles of 30 nm and having been subjected to a hydrophobic treatment were mixed with and externally added to 100 parts by weight of the colored resin particles by using a Herschel mixer to produce mother particles of colored particles.

### (Preparation of Colored Particles)

1.5 parts by weight of silica particles with large diameter having a volume average particle diameter of 100 nm and having been subjected to a hydrophobic treatment were mixed with and externally added to 100 parts by weight of the mother particles by using a Herschel mixer to produce colored particles having a coverage of the external additive of 15.5%.

### (Preparation of Magnetic Particles)

Spherical ferrite particles having a volume average particle diameter of 40 μm were prepared, and a surface coated layer was formed by coating the surface thereof completely with a silicone resin to produce magnetic particles as a carrier.

### (Evaluation of Charge Amounts of Mother Particles and Colored Particles)

The mother particles and the colored particles each were mixed with the magnetic particles at concentration ratios thereof of 7% by weight, respectively, followed by agitating with a turbulence shaker for 30 minutes, to produce mixed samples for each. Measurement of average charge amounts per weight of the mother particles and the colored particles by a suction blow off method revealed that the charge amount of the mother particles was −63 μC/g, whereas the charge amount of the colored particles was −40 μC/g, which was smaller in charge amount than the mother particles.

Measurement of dependency of the charge amount on the ratio of the colored particles revealed that a sharp charge amount distribution was obtained at a concentration of the colored particles (weight ratio) providing a coverage of about 40% with respect to the magnetic particles having a particle diameter of 40 μm.

### (Evaluation of Image)

The colored particles and the magnetic particles were mixed at a specific concentration of the colored particles of 7 parts by weight, followed by agitating with a turbulence shaker for 30 minutes, to produce a developing agent, which was subjected to evaluation of an image.

The developing agent thus prepared was placed in an image forming apparatus by the two-component developing process as shown in FIG. 5, and an image was formed. As a result, a high transfer efficiency of 95% was obtained. Under a low temperature and low humidity environment and a high temperature and high humidity environment, a transfer efficiency of 95%-1% or more could be maintained within a range of fine adjustment of the transfer bias. No scattering of the toner was observed around the image.

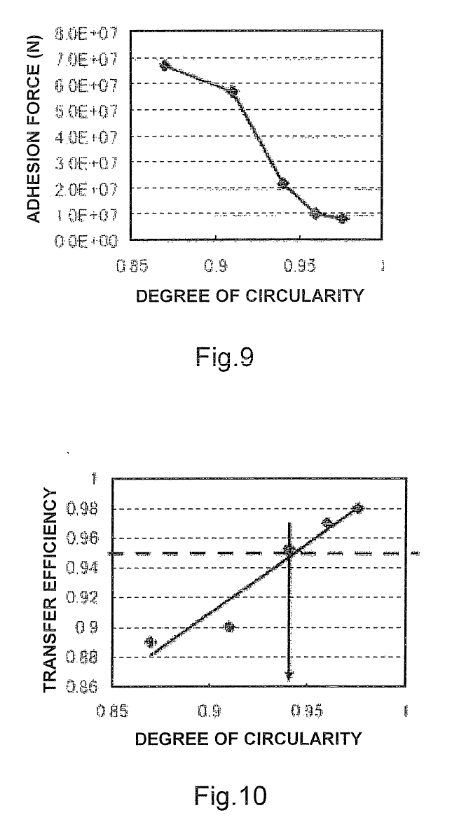

The adhesion force and the transfer efficiency were measured with variation in degree of circularity by changing the temperature and the treating time of the conglobation treatment of the mother particles of the developing agent prepared in this embodiment. The results are shown in FIGS. 9 and 10, respectively. The transfer efficiency was measured by placing the developing agent in the image forming apparatus of the cleaner-less process as shown in FIG. 6. As shown in the figures, it was understood that when the degree of circularity was decreased, the adhesion force was increased, and the transfer efficiency was deteriorated.

### EXAMPLE 2

Colored particles and magnetic particles were prepared and evaluated similarly to Example 1.

### (Preparation of Mother Particles)

Mother particles as a raw material of respective colored particles were prepared. 28 parts by weight of a polyester resin, 7 parts by weight of Carmine 6B7, 5 parts by weight of rice wax and 1 part by weight of carnauba wax were kneaded with Kneadex, produced by YPK Corp. to produce a master batch. After coarsely pulverizing, 58 parts by weight or a polyester resin and 1 part by weight of CCA were added thereto, and after kneading, coarsely pulverizing and finely pulverizing, particles of 8 μm or more and 3 μm or less were removed by elbow jet classification to produce colored resin particles having a volume average particle diameter of 6.3 μm. The colored resin particles were subjected a conglobation treatment to make into a potato-like shape having a degree of sphericity of 0.94. 2.5 parts by weight of silica fine particles having a volume average particle diameter of primary particles of 20 nm and having been subjected to a hydrophobic treatment and 1 part by weight of rutile type titanium oxide having a volume average particle diameter of primary particles of 30 nm and having been subjected to a hydrophobic treatment were mixed with and externally added to 100 parts by weight of the colored resin particles by using a Herschel mixer to produce mother particles of colored particles.

### (Preparation of Colored Particles)

2 parts by weight of brookite type titanium oxide having a volume average particle diameter of 70 nm and having been subjected to a hydrophobic treatment was mixed with and externally added to 100 parts by weight of the mother particles by using a Herschel mixer to produce colored particles having a coverage of the external additive of 13.5%.

### (Evaluation of Charge Amounts of Mother Particles and External Additive)

Measurement of the charge amount of the colored particles similar to Example 1 revealed −46 μC/g.

Measurement of dependency of the charge amount on the ratio of the colored particles similar to Example 1 revealed that a sharp charge amount distribution was obtained at a concentration of the colored particles (weight ratio) providing a coverage of about 40% with respect to the magnetic particles having a particle diameter of 40 μm.

The mother particles were mixed with the magnetic particles at a concentration ratio thereof of 15% by weight, followed by agitating with a turbulence shaker for 30 minutes, to produce a mixed sample of the mother particles. Brookite type titanium oxide having a volume average particle diameter of 70 nm and having been subjected to a hydrophobic treatment was mixed with the magnetic particles at a concentration ratio thereof of 4% by weight, followed by agitating with a turbulence shaker for 30 minutes, to produce a mixed sample of the external additive.

The silicone resin, which was a resin constituting the surface coated layer of the magnetic particles, was molded into a plate, which was adhered with no space on inner walls of a box having a lid with an area of the bottom surface of 200 cm² or more. 40 g of the mixed sample of the mother particles thus prepared was placed in the box, and after closing the lid, the box was shaken for 10 minutes. The magnetic particles were completely removed, and the mother particles attached to the bottom surface of the box and the charge amount thereof were measured by a suction blow off method. As a result, the charge amount per surface area q/s calculated from q/m was −6.5×10⁻⁵ C/m².

40 g of the mixed sample of the external additive thus prepared was placed in the box having been prepared similarly, and after closing the lid, the box was shaken for 10 minutes. The magnetic particles were completely removed similarly, and the mother particles attached to the bottom surface of the box and the charge amount thereof were measured by a suction blow off method. As a result, the charge amount per surface area q/s calculated from q/m was −4.0×10⁻⁵ C/m². Accordingly, it was understood that the charge amount per surface area of the external additive was smaller than the mother particles.

### (Evaluation of Image)

The colored particles and the magnetic particles prepared similarly to Example 1 were mixed at a specific concentration of the colored particles of 6.5 parts by weight, followed by agitating with a turbulence shaker for 30 minutes, to produce a developing agent, which was subjected to evaluation of an image similarly as in Example 1.

The developing agent thus prepared was placed in an image forming apparatus by the two-component developing process as shown in FIG. 5 as similar to Example 1, and an image was formed. As a result, a high transfer efficiency of 96% was obtained. Under a low temperature and low humidity environment and a high temperature and high humidity environment, a transfer efficiency of 96%-1% or more could be maintained within a range of fine adjustment of the transfer bias. No scattering of the toner was observed around the image.

### EXAMPLE 3

Colored particles and magnetic particles were prepared and evaluated similarly to Example 1.

### (Preparation of Colored Particles)

2 parts by weight of truly spherical fine particles having a volume average particle diameter of 300 nm were mixed with and externally added to 100 parts by weight of the mother particles by using a Herschel mixer similarly to Example 1, so as to produce colored particles having a coverage of the external additive of 10.1%.

### (Evaluation of Charge Amount of Colored Particles)

Measurement of the charge amount of the colored particles similar to Example 1 revealed −58 μC/g.

Measurement of dependency of the charge amount on the ratio of the colored particles similar to Example 1 revealed that a sharp charge amount distribution was obtained at a concentration of the colored particles (weight ratio) providing a coverage of about 40% with respect to the magnetic particles having a particle diameter of 40 μm.

### (Evaluation of Image)

The colored particles and the magnetic particles prepared similarly to Example 1 were mixed at a specific concentration of the colored particles of 7 parts by weight, followed by agitating with a turbulence shaker for 30 minutes, to produce a developing agent, which was subjected to evaluation of an image similarly as in Example 1.

The developing agent thus prepared was placed in an image forming apparatus by the two-component developing process as shown in FIG. 5 as similar to Example 1, and an image was formed. As a result, a high transfer efficiency of 97% was obtained. Furthermore, the external additive was not buried in or released from the mother particles with the lapse of time and could maintain the function as a spacer. As a result of a life test of 90,000 sheets, the favorable transfer characteristics and the high image quality could be maintained.

### EXAMPLE 4

Colored particles and magnetic particles were prepared and evaluated similarly to Example 1.

### (Preparation of Mother Particles)

Mother particles as a raw material of respective colored particles were prepared. 28 parts by weight of a polyester resin, 7 parts by weight of Carmine 6B7, 5 parts by weight of rice wax and 1 part by weight of carnauba wax were kneaded with Kneadex, produced by YPK Corp. to produce a master batch. After coarsely pulverizing, 58 parts by weight or a polyester resin and 1 part by weight of CCA were added thereto, and after kneading, coarsely pulverizing and finely pulverizing, particles of 7 μm or more and 3 μm or less were removed by elbow jet classification to produce colored resin particles having a volume average particle diameter of 5.3 μm. The colored resin particles were subjected a conglobation treatment to make into an approximately truly spherical shape having a degree of sphericity of 0.96. 2.5 parts by weight of silica fine particles having a volume average particle diameter of primary particles of 20 nm and having been subjected to a hydrophobic treatment and 0.5 part by weight of rutile type titanium oxide having a volume average particle diameter of primary particles of 30 nm and having been subjected to a hydrophobic treatment were mixed with and externally added to 100 parts by weight of the colored resin particles by using a Herschel mixer to produce mother particles of colored particles.

### (Preparation of Colored Particles)

1.7 parts by weight of silica particles with large diameter having a volume average particle diameter of 100 nm and having been subjected to a hydrophobic treatment were mixed with and externally added to 100 parts by weight of the mother particles by using a Herschel mixer similarly to Example 1, so as to produce colored particles.

### (Evaluation of Image)

The colored particles and the magnetic particles prepared similarly to Example 1 were mixed to produce a developing agent, which was subjected to evaluation of an image.

The developing agent thus prepared was placed in an image forming apparatus by the two-component developing process as shown in FIG. 5, and an image was formed. As a result, a high transfer efficiency of 97% was obtained. As a result of a life test of 150,000 sheets at 6% printing ratio, the external additive was not buried in or released from the mother particles with the lapse of time and could maintain the function as a spacer, and the favorable transfer characteristics and the high image quality could be maintained.

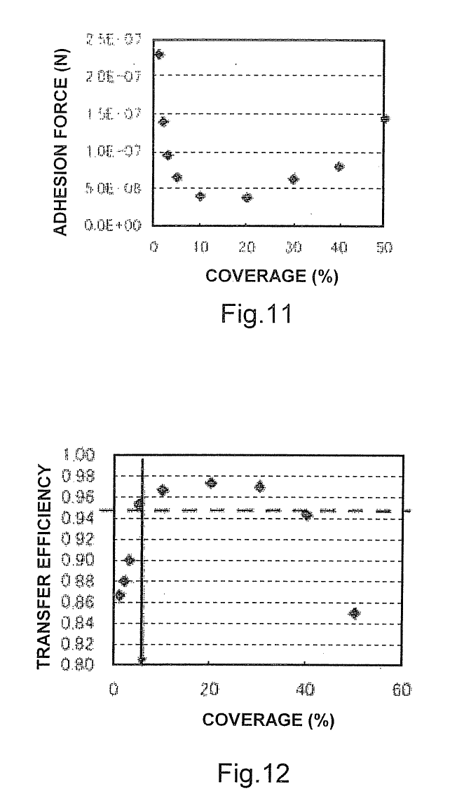

The adhesion ratio and the transfer efficiency were measured with variation in coverage by changing the addition amount of the silica particles with large diameter of the developing agent prepared in this embodiment. The results are shown in FIGS. 11 and 12, respectively. Since silica substantially is not charged negatively with respect to the surface coating agent of the carrier, the charge amount of the toner is lowered when the charge amount is increased. Accordingly, silica having a volume average particle diameter of 20 nm and titanium oxide having a volume average particle diameter of 30 nm were added to the mother particles in such a manner that the charge amount of the toner became −40 μC/g when the mixing ratio with the carrier was 7 parts by weight, so as to control the charge amount. The charge amount can be increased by increasing the fine silica and by decreasing the titanium oxide. As shown in the figures, it was understood that the adhesion force is suppressed to obtain a high transfer efficiency at a coverage of the external additive of from 5 to 40%.

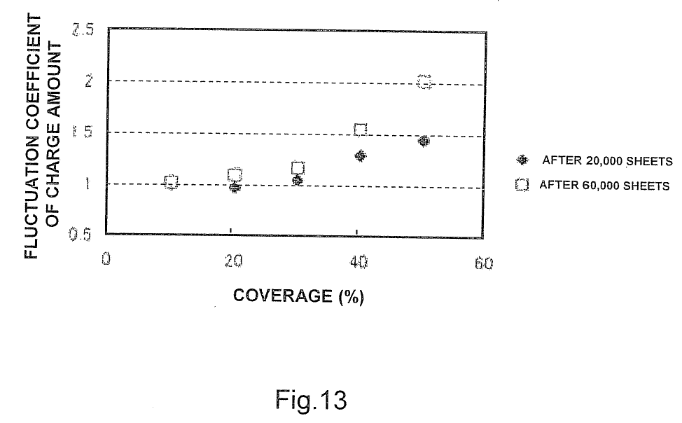

Furthermore, the developing agent, which was varied in coverage of the silica particles with large diameter by controlling the charge amount to −40 μC/g with the addition amounts of the fine silica and the titanium oxide, was placed in an image forming apparatus by the cleaner-less process as shown in FIG. 6 and subjected to a life test to measure the dependency of the fluctuation coefficient of the charge amount on the coverage after 20,000 sheets, 60,000 sheets. The results are shown in FIG. 13. As shown in the figure, when the coverage was large, the charge amount of the toner was increased due to release of the external additive from the mother particles through stress caused by lapse of life. As a result, the image density was lowered, and the transfer efficiency was deteriorated.

This is because the fine particles that are poor in charging capability as compared to the mother particles are used as the external additive, whereby the charge amount after releasing the external additive is increased as compared to that before releasing. In order to ensure the desired charge amount, it is necessary to set the charging capability of the mother particles higher when the coverage (addition amount) is larger. Accordingly, the increasing ratio of the charge amount upon releasing the external additive becomes larger. Therefore, the coverage is preferably 30% or less from the standpoint of making the external additive hard to be released and suppressing the fluctuation in charge amount upon releasing.

### EXAMPLE 5

Colored particles and magnetic particles were prepared and evaluated similarly to Example 1.

### (Preparation of Mother Particles)

Mother particles as a raw material of respective colored particles were prepared. 30 parts by weight of a styrene-acrylic resin, 7 parts by weight of carbon black and 4 parts by weight of carnauba wax were kneaded with Kneadex, produced by YPK Corp. to produce a master batch. After coarsely pulverizing, 58 parts by weight or a polyester resin and 1 part by weight of CCA were added thereto, and after kneading, coarsely pulverizing and finely pulverizing, particles of 7 μm or more and 3 μm or less were removed by elbow jet classification to produce colored resin particles having a volume average particle diameter of 5.5 μm. The colored resin particles were subjected to a conglobation treatment to make into a potato-like shape having a degree of sphericity of 0.94. 2.5 parts by weight of silica fine particles having a volume average particle diameter of primary particles of 20 nm and having been subjected to a hydrophobic treatment and 0.5 part by weight of rutile type titanium oxide having a volume average particle diameter of primary particles of 30 nm and having been subjected to a hydrophobic treatment were mixed with and externally added to 100 parts by weight of the colored resin particles by using a Herschel mixer to produce mother particles of colored particles.

### (Preparation of Colored Particles)

1.7 parts by weight of silica particles with large diameter having a volume average particle diameter of 100 nm and having been subjected to a hydrophobic treatment were mixed with and externally added to 100 parts by weight of the mother particles by using a Herschel mixer similarly to Example 1, so as to produce colored particles.

### (Preparation of Magnetic Particles)

Spherical ferrite particles having a volume average particle diameter of 40 μm were prepared, and a surface coated layer was formed by coating the surface thereof at 70% with a resin obtained by dispersing 5 parts by weight of silica having a volume average particle diameter of 20 nm in 100 parts by weight of an acrylic resin, so as to produce magnetic particles as a carrier.

### (Evaluation of Image)

The colored particles and the magnetic particles were mixed at a specific concentration of the colored particles of 6 parts by weight to produce a developing agent, which was subjected to evaluation of an image.

The developing agent thus prepared was placed in an image forming apparatus by the two-component developing process as shown in FIG. 5, and an image was formed. As a result, a high transfer efficiency of 97%, which was considerably high with the mother particles having a potato-like shape, was obtained. Furthermore, a favorable image was obtained.

The developing agents obtained in Examples 1 to 5 were placed in an image forming apparatus by the cleaner-less process as shown in FIG. 6, and an image was formed. As a result, the transfer efficiency was maintained at 95% or more under a low temperature and low humidity environment and a high temperature and high humidity environment and in the life test. Accordingly, a favorable image quality could be maintained without formation of negative memory due to inhibition of the next exposure by the colored particles remaining after transferring or formation of positive memory due to incomplete recovery by the developing device.

In the developing agents obtained in Examples 1 to 5, the pigment to be added was changed to Carmine 6B as a magenta pigment, Pigment Yellow L as a yellow pigment, Phthalocyanine Blue as a cyan pigment, and carbon black as a black pigment, which were similarly mixed, and the similar conglobation treatment and externally addition treatment were carried out to produce colored particles of the respective colors. Developing agents were prepared by mixing with the magnetic particles similarly. The developing agents were placed in an image forming apparatus by the four-unit tandem process as shown in FIG. 7, and an image was formed.

As a result, a transfer efficiency of 95% or more could be obtained to suppress the waste toner amount in all the colors. It was found that since the developing agents were designed to suppress the increase in electrostatic adhesion force with a high charge amount of the colored particles as having been described above, a favorable transfer efficiency was obtained at a power voltage of about 1,000 V for applying the transfer bias voltage to the transfer roller even when the charge amount of the colored particles was set at a higher value of from −40 to −60 μC/g. Accordingly, the transfer electric field was not high with a large charge amount of the toner, whereby such problems could be suppressed from occurring as decrease in image density due to formation of reverse transfer, scattering of the colored particles, and dropouts in the image.

The developing agents were similarly placed in an image forming apparatus of the four-unit tandem cleaner-less process, and an image was formed. As a result, all the colored particles could suppress formation of negative memory or positive memory due to transfer residues or reverse transfer and problems due to color mixing in the developing device from occurring.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising:
colored particles containing mother particles, the mother particles containing at least a resin and a colorant, and a first external additive, the first external additive covering a surface of the mother particles, and
magnetic particles having a surface coated layer on at least a part of a surface thereof, the surface coated layer thereof containing an organic material,
wherein a charge amount q₁ per weight of the mother particles with respect to the surface coated layer and a charge amount q₂ per weight of the colored particles with respect to the surface coated layer satisfy |q₁|≧|q₂|.

2. The developing agent according to claim 1, wherein the first external additive is inorganic or organic, and spherical or planular fine particles.

3. The developing agent according to claim 1, wherein the first external additive has a volume average particle diameter of from 50 to 500 nm.

4. The developing agent according to claim 1, wherein a coverage of the first external additive on the surface of the mother particles is from 5 to 30%.

5. The developing agent according to claim 1, wherein the mother particles are in a spherical shape with a degree of circularity of from 0.94 to 1.

6. The developing agent according to claim 1, wherein the mother particles have a volume average particle diameter of from 2.5 to 7 μm.

7. The developing agent according to claim 1, wherein the mother particles contain a second external additive, and the second external additive has a volume average particle diameter smaller than a volume average particle diameter of the first external additive.

8. The developing agent according to claim 7, wherein the second external additive has a volume average particle diameter of from 10 to 100 nm.

9. The developing agent according to claim 1, wherein the magnetic particles are ferrite, magnetite, iron oxide or resin particles mixed with magnetic powder.

10. A developing agent comprising:
colored particles containing mother particles, the mother particles containing at least a resin and a colorant, and a first external additive, the first external additive covering a surface of the mother particles, and
magnetic particles having a surface coated layer on at least a part of a surface thereof, the surface coated layer thereof containing an organic material,
wherein a charge amount qₜ per surface area of the mother particles with respect to the surface coated layer and a charge amount q₀ per weight of the external additive with respect to the surface coated layer satisfy |qₜ|≧|q₀|.

11. The developing agent according to claim 10, wherein the first external additive is inorganic or organic spherical or planular fine particles.

12. The developing agent according to claim 10, wherein the first external additive has a volume average particle diameter of from 50 to 500 nm.

13. The developing agent according to claim 10, wherein a coverage of the first external additive on the surface of the mother particles is from 5 to 30%.

14. The developing agent according to claim 10, wherein the mother particles are in a spherical shape with a degree of circularity of from 0.94 to 1.

15. The developing agent according to claim 10, wherein the mother particles have a volume average particle diameter of from 2.5 to 7 μm.

16. The developing agent according to claim 10, wherein the mother particles contain a second external additive, and the second external additive has a volume average particle diameter smaller than a volume average particle diameter of the first external additive.

17. The developing agent according to claim 16, wherein the second external additive has a volume average particle diameter of from 10 to 100 nm.

18. The developing agent according to claim 10, wherein the magnetic particles are ferrite, magnetite, iron oxide or resin particles mixed with magnetic powder.
